(19) United States
(12) Patent Application Publication
(10) Pub. No.: US 2021/0367462 A1
(43) Pub. Date: Nov. 25, 2021

(54) A ROTOR OF A SYNCHRONOUS RELUCTANCE MACHINE AND A METHOD FOR MANUFACTURING THE SAME

(71) Applicant: Lappeenrannan-Lahden teknillinen yliopisto LUT, LAPPEENRANTA (FI)

(72) Inventors: Juha PYRHÖNEN, LAPPEENRANTA (FI); Jussi SOPANEN, LAPPEENRANTA (FI)

(21) Appl. No.: 16/760,818

(22) PCT Filed: Nov. 7, 2018
(86) PCT No.: PCT/FI2018/050818

§ 371 Date: Apr. 30, 2020

(30) Foreign Application Priority Data
Nov. 9, 2017 (FI) 20176003

(51) Int. Cl. H02K 1/24; H02K 1/32; H02K 19/10; H02K 19/24

(52) U.S. Cl. CPC H02K 1/246; H02K 19/24; H02K 19/103; H02K 1/32

(57) ABSTRACT

A rotor for a synchronous reluctance machine includes a first layered structure having ferromagnetic sheets stacked in a direction of a quadrature axis of the rotor and being separated from each other by layers of non-ferromagnetic material, a second layered structure similar to the first layered structure, and a ferromagnetic center part between the first and second layered structures in the direction of the quadrature axis and attached to the first and second layered structures. The ferromagnetic center part is a single piece of ferromagnetic material that is wider in a direction of the direct axis of the rotor than in the direction of the quadrature axis. The width of the ferromagnetic center part in the direction of the quadrature axis is greater than a thickness of each ferromagnetic sheet in order to improve the mechanical strength of the rotor.

### FIELD OF THE TECHNOLOGY

The disclosure relates generally to rotating electric machines. More particularly, the disclosure relates to a rotor of a synchronous reluctance machine. Furthermore, the disclosure relates to a synchronous reluctance machine and to a method for manufacturing a rotor of a synchronous reluctance machine.

### BACKGROUND

Rotating electric machines, such as motors and generators, generally comprise a rotor and a stator which are arranged such that a magnetic flux is developed between these two. A rotor of a synchronous reluctance machine comprises typically a ferromagnetic core structure and a shaft. The ferromagnetic core structure is arranged to have different reluctances in the direct d and quadrature q directions of the rotor. Thus, the synchronous reluctance machine has different inductances in the direct and quadrature directions and thereby the synchronous reluctance machine is capable of generating torque without a need for electric currents and/or permanent magnets in the rotor.

Different reluctances in the direct and quadrature directions can be achieved for example with salient poles so that the airgap is wider in the direction of the quadrature axis than in the direction of the direct axis. Typically, a salient pole rotor is however not suitable for high speed applications where the airgap should be smooth and where mechanical stress maxima in the rotor construction should be minimized as well as possible. Another approach to provide different reluctances in the direct and quadrature directions is based on cuttings in a rotor structure so the cuttings increase the reluctance in the direction of the quadrature axis more than in the direction of the direct axis. This approach is straightforward to use in cases where a rotor has a laminated structure comprising ferromagnetic sheets stacked in the axial direction of the rotor since the cuttings can be made on the sheets one-by-one. The approach based on the cuttings is however not free from challenges. One of the challenges is related to isthmuses formed by the cuttings because high local mechanical stresses may take place in the isthmuses and thereby the isthmuses may constitute weak points of the rotor structure. A third approach to provide different reluctances in the direct and quadrature directions is based on a stack of ferromagnetic sheets which are separated from each other with layers of non-ferromagnetic material so that the reluctance is greater in a direction perpendicular to the sheets than in a direction parallel with the sheets. This approach is typically used in synchronous reluctance machines having two or more pole-pairs and it may be challenging in conjunction with a synchronous reluctance machine having only one pole-pair.

### SUMMARY

The following presents a simplified summary in order to provide a basic understanding of some embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new rotor for a synchronous reluctance machine that has only one pole-pair. A rotor according to the invention comprises:
a first layered structure comprising first ferromagnetic sheets stacked in a direction of the quadrature q axis of the rotor, the first ferromagnetic sheets being separated from each other by first layers of non-ferromagnetic material,
a second layered structure comprising second ferromagnetic sheets stacked in the direction of the quadrature axis, the second ferromagnetic sheets being separated from each other by second layers of the non-ferromagnetic material, and
a ferromagnetic center part located between the first and second layered structures in the direction of the quadrature axis and attached to the first and second layered structures.

The above-mentioned ferromagnetic center part is a single piece of ferromagnetic material that is wider in the direction of the direct d axis of the rotor than in the direction of the quadrature axis, and the width of the ferromagnetic center part in the direction of the quadrature axis is greater than the thickness of each of the above-mentioned ferromagnetic sheets. The ferromagnetic center part which is made of solid ferromagnetic material and which is thicker than the ferromagnetic sheets improves the mechanical strength of the rotor compared to a situation where a layered structure extends through a rotor because greatest mechanical stresses caused by the centrifugal force take typically place at the geometric axis of rotation or in its vicinity. Thus, in the above-described rotor, the solid ferromagnetic material is utilized in the area where maximal mechanical stresses may occur.

In accordance with the invention, there is provided also a new synchronous reluctance machine. A synchronous reluctance machine according to the invention comprises:
a stator comprising stator windings for generating a rotating magnetic field in response to being supplied with alternating currents, and
a rotor according to the invention, the rotor being rotatably supported with respect to the stator.

In accordance with the invention, there is provided also a new method for manufacturing a rotor of a synchronous reluctance machine having only one pole-pair. A method according to the invention comprises:
stacking first ferromagnetic sheets and first layers of non-ferromagnetic material so as to form a first layered structure where the first layers of the non-ferromagnetic material separate the first ferromagnetic sheets from each other,
stacking second ferromagnetic sheets and second layers of the non-ferromagnetic material so as to form a second layered structure where the second layers of the non-ferromagnetic material separate the second ferromagnetic sheets from each other,
stacking the first layered structure, a ferromagnetic center part, and the second layered structure so that the ferromagnetic center part is, in the direction of the quadrature q axis of the rotor, between the first and second layered structures and the first and second ferromagnetic sheets are stacked in the direction of the quadrature axis, the ferromagnetic center part being a single piece of ferromagnetic material that is wider in the direction of the direct d axis of the rotor than in the direction of the quadrature axis, and the width of the ferromagnetic center part in the direction of the quadrature axis being greater than the thickness of each of the ferromagnetic sheets, and
attaching the first and second ferromagnetic sheets, the first and second layers of the non-ferromagnetic material, and the ferromagnetic center part together to constitute a uniform element.

Various exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in conjunction with the accompanying drawings.

The verbs “to comprise” and “to include” are used in this document as open limitations that neither exclude nor require the existence of also un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below in the sense of examples and with reference to the accompanying drawings, in which:

FIGS. 1a and 1b illustrate a rotor according to an exemplifying and non-limiting embodiment of the invention,

FIGS. 2a and 2b illustrate a rotor according to another exemplifying and non-limiting embodiment of the invention,

FIGS. 2c, 2d, 2e, and 2f illustrate a rotor according to an exemplifying and non-limiting embodiment of the invention,

FIG. 3 illustrates a synchronous reluctance machine according to an exemplifying and non-limiting embodiment of the invention,

FIG. 4 shows a flowchart of a method according to an exemplifying and non-limiting embodiment of the invention for manufacturing a rotor of a synchronous reluctance machine, and

FIGS. 5a and 5b illustrate a method according to an exemplifying and non-limiting embodiment of the invention for manufacturing a rotor of a synchronous reluctance machine.

### DESCRIPTION OF EXEMPLIFYING AND NON-LIMITING EMBODIMENTS

The specific examples provided in the description given below should not be construed as limiting the scope and/or the applicability of the appended claims. Furthermore, it is to be understood that lists and groups of examples provided in the description given below are not exhaustive unless otherwise explicitly stated.

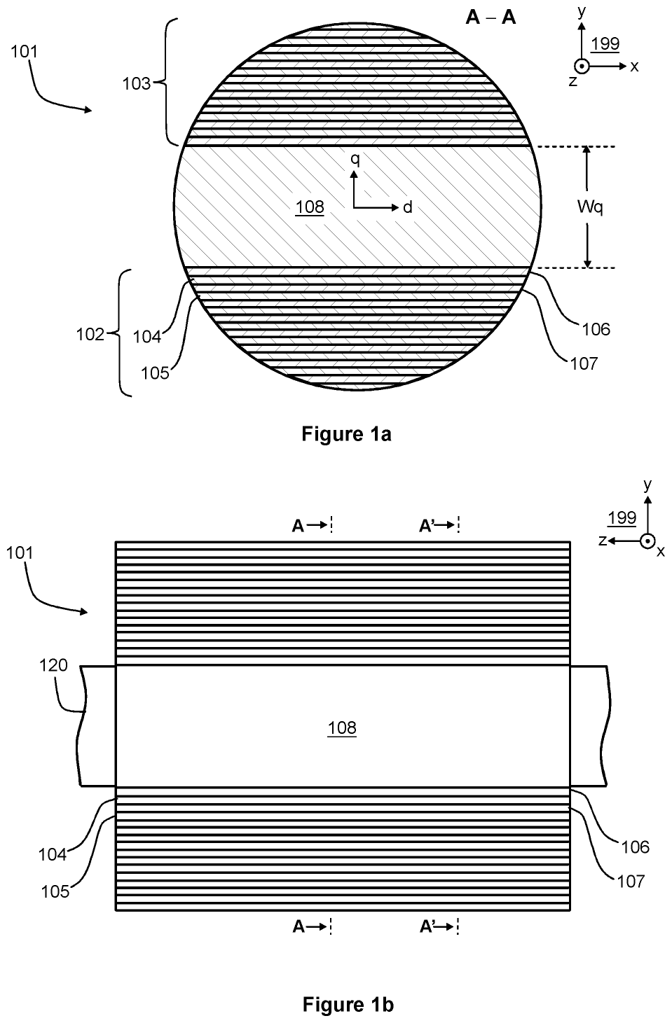

FIG. 1a shows a cross-section of a rotor 101 according to an exemplifying and non-limiting embodiment of the invention, and FIG. 1b shows a side view of the rotor 101. The cross-section shown in FIG. 1a is taken along a line A-A shown in FIG. 1b so that the geometric section plane is parallel with the xy-plane of a coordinate system 199. In this exemplifying case, it is assumed that the cross-section is the same at different axial positions on the active part of the rotor, e.g. a cross-section taken along a line A′-A′ shown in FIG. 1b is the same as the cross-section shown in FIG. 1a. The rotor 101 comprises a first layered structure 102 that comprises first ferromagnetic sheets stacked in the direction of the quadrature q axis of the rotor 101. The first ferromagnetic sheets are separated from each other by first layers of non-ferromagnetic material. In FIGS. 1a and 1b, two of the first ferromagnetic sheets are denoted with references 104 and 105 and two of the first layers of the non-ferromagnetic material are denoted with references 106 and 107. The rotor 101 comprises a second layered structure 103 which is similar to the first layered structure 102 and which comprises second ferromagnetic sheets stacked in the direction of the q-axis. The second ferromagnetic sheets are separated from each other by second layers of the non-ferromagnetic material. The rotor 101 comprises a ferromagnetic center part 108 which is located between the first and second layered structures 102 and 103 in the direction of the q-axis and which is attached to the first and second layered structures. The ferromagnetic center part 108 is a single piece of ferromagnetic material that is wider in the direction of the direct d axis of the rotor than in the direction of the q-axis. The width Wq of the ferromagnetic center part 108 in the direction of the q-axis is greater than the thickness of each of the first and second ferromagnetic sheets. Due to the above-mentioned layers of the non-ferromagnetic material, the reluctance of the rotor 101 is greater in the direction of the q-axis than in the direction of the d-axis. As a skilled reader can understand based on FIG. 1a, the ferromagnetic center part 108 constitutes a part of a flow path for a magnetic flux when the rotor 101 is acting as a rotor of a synchronous reluctance machine. A shaft 120 can be, for example but not necessarily, the same piece of material as the ferromagnetic center part 108.

In a rotor according to an exemplifying and non-limiting embodiment of the invention, the width Wq of the ferromagnetic center part 108 in the direction of the q-axis is at least three times the thickness of the ferromagnetic sheets. In a rotor according to an exemplifying and non-limiting embodiment of the invention, the width Wq of the ferromagnetic center part 108 in the direction of the q-axis is at least five times the thickness of the ferromagnetic sheets. In a rotor according to an exemplifying and non-limiting embodiment of the invention, the width Wq of the ferromagnetic center part 108 in the direction of the q-axis is at least ten times the thickness of the ferromagnetic sheets. The ferromagnetic center part 108 which is made of solid ferromagnetic material and which is thicker than the ferromagnetic sheets improves the mechanical strength of the rotor 101 compared to a situation where a layered structure extends through a rotor because strongest mechanical stresses caused by the centrifugal force take place typically at the geometric axis of rotation, i.e. in the ferromagnetic center part 108.

In a rotor according to an exemplifying and non-limiting embodiment of the invention, the ferromagnetic sheets and the ferromagnetic center part 108 are made of ferromagnetic steel and the non-ferromagnetic material between adjacent ones of the ferromagnetic sheets is austenitic steel. Furthermore, there can be layers of the non-ferromagnetic material between the ferromagnetic center part 108 and ferromagnetic sheets closest to the ferromagnetic center part 108. It is however also possible that the ferromagnetic sheets closest to the ferromagnetic center part 108 are directly attached to the ferromagnetic center part 108. Depending on mechanical stresses, it is also possible that the non-ferromagnetic material is for example copper or brass. The ferromagnetic material and the non-ferromagnetic material are advantageously selected so that their coefficients of thermal expansion are close to each other.

A rotor according to an exemplifying and non-limiting embodiment of the invention comprises solder or brazing joints for attaching the ferromagnetic sheets, the layers of the non-ferromagnetic material, and the ferromagnetic center part 108 together to constitute a uniform element. A rotor according to another exemplifying and non-limiting embodiment of the invention comprises diffusion welded joints for attaching the ferromagnetic sheets, the layers of the non-ferromagnetic material, and the ferromagnetic center part 108 together to constitute a uniform element.

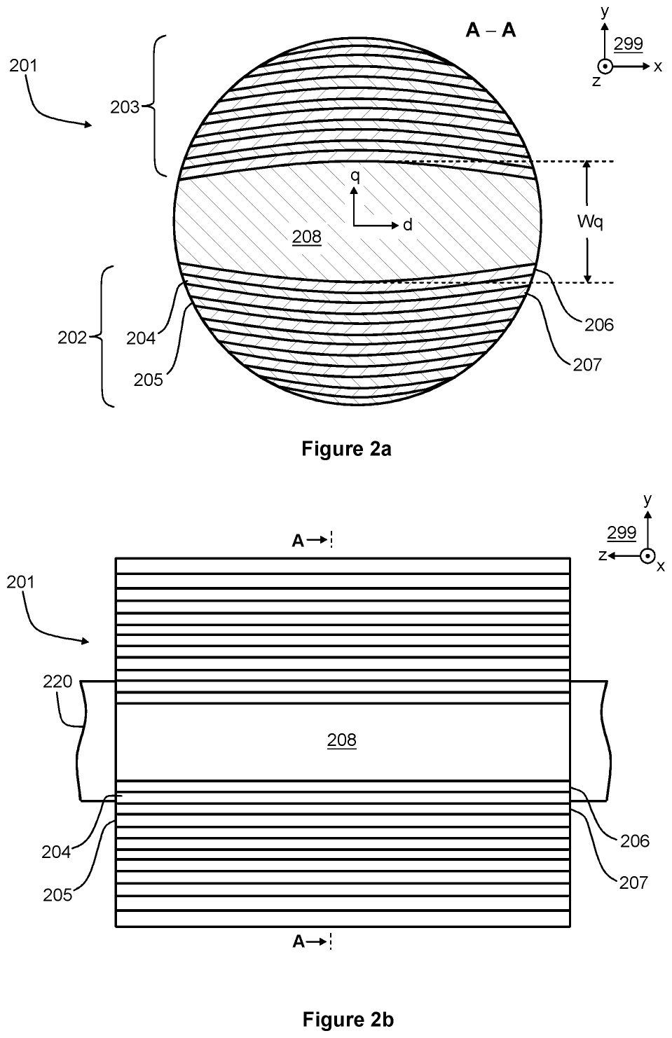

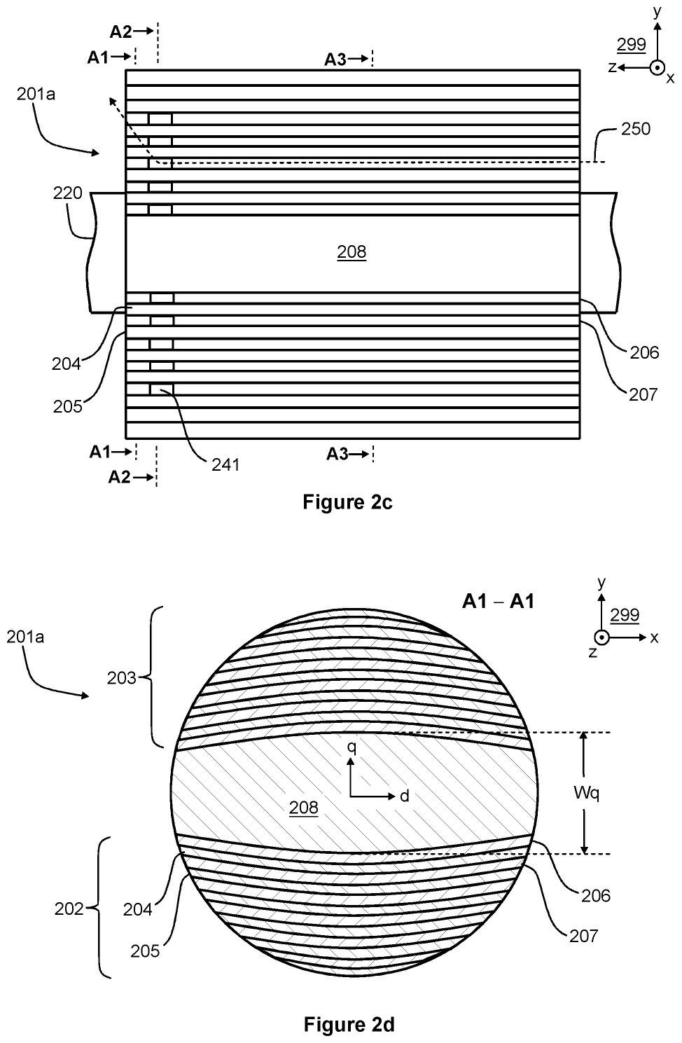

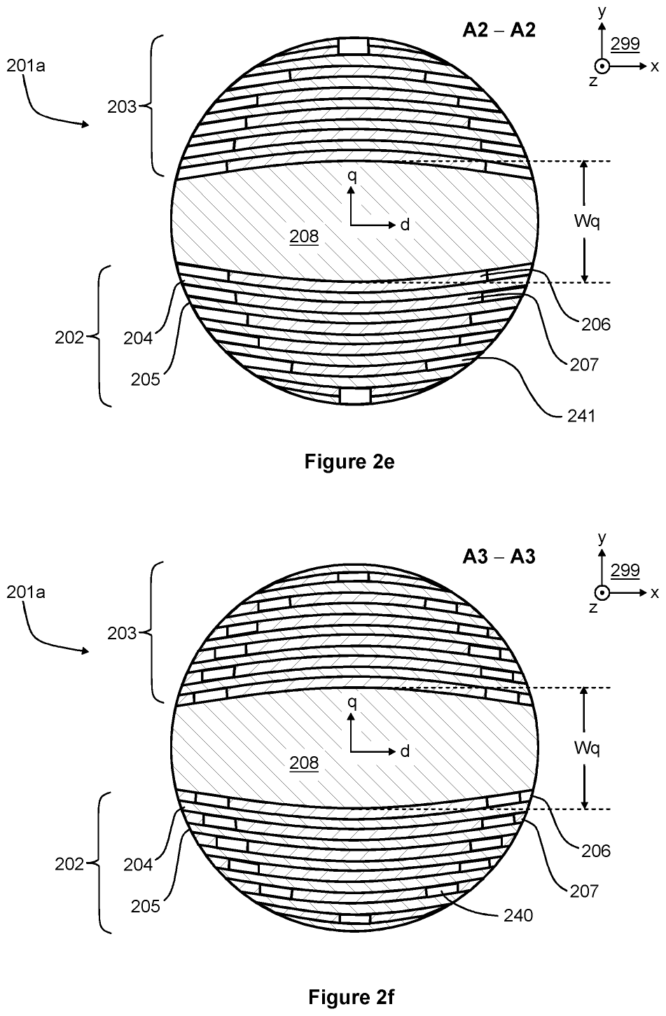

In the exemplifying rotor 101 illustrated in FIGS. 1a and 1b, the ferromagnetic sheets are planar and surfaces of the ferromagnetic center part 108 attached to the first and second layered structures 102 and 103 are planar and parallel with each other. FIG. 2a shows a cross-section of a rotor 201 according to another exemplifying and non-limiting embodiment of the invention, and FIG. 2b shows a side view of the rotor 201. The cross-section shown in FIG. 2a is taken along a line A-A shown in FIG. 2b so that the geometric section plane is parallel with the xy-plane of a coordinate system 299. In this exemplifying case, it is assumed that the cross-section is the same at different axial positions on the active part of the rotor 201. The rotor 201 comprises a first layered structure 202 that comprises first ferromagnetic sheets stacked in the direction of the quadrature q axis of the rotor 201. The first ferromagnetic sheets are separated from each other by first layers of non-ferromagnetic material. In FIGS. 2a and 2b, two of the first ferromagnetic sheets are denoted with references 204 and 205 and two of the first layers of the non-ferromagnetic material are denoted with references 206 and 207. The rotor 201 comprises a second layered structure 203 which is similar to the first layered structure 202 and which comprises second ferromagnetic sheets stacked in the direction of the q-axis. The second ferromagnetic sheets are separated from each other by second layers of the non-ferromagnetic material. The rotor 201 comprises a ferromagnetic center part 208 which is located between the first and second layered structures 202 and 203 in the direction of the q-axis and which is attached to the first and second layered structures. The ferromagnetic center part 208 is a single piece of ferromagnetic material that is wider in the direction of the direct d axis of the rotor than in the direction of the q-axis. The width Wq of the ferromagnetic center part 208 in the direction of the q-axis is greater than the thickness of each of the first and second ferromagnetic sheets. A shaft 220 of the rotor 201 can be, for example but not necessarily, the same piece of material as the ferromagnetic center part 208.

In the exemplifying rotor 201 illustrated in FIGS. 2a and 2b, the ferromagnetic sheets are curved having concave sides towards the ferromagnetic center part 208. Correspondingly, surfaces of the ferromagnetic center part 208 which are attached to the first and second layered structures 202 and 203 are curved so that the width of the ferromagnetic center part 208 in the direction of the q-axis is tapering towards edges of the ferromagnetic center part 208. The curved shapes of the ferromagnetic sheets, of the layers of the non-ferromagnetic material, and of the ferromagnetic center part 208 help reducing mechanical stresses between the ferromagnetic and non-ferromagnetic materials. In FIG. 2a, the width Wq means the maximum width of the ferromagnetic center part 208 in the direction of the q-axis. The width Wq can be for example at least 3, 5, or 10 times the thickness of each ferromagnetic sheet.

FIG. 2c shows a side view of a rotor 201a according to an exemplifying and non-limiting embodiment of the invention. FIGS. 2d, 2e, and 2f show cross-sections of the rotor 201a so that the cross-section shown in FIG. 2d is taken along a line A1-A1 shown in FIG. 2c, the cross-section shown in FIG. 2e is taken along a line A2-A2 shown in FIG. 2c, and the cross-section shown in FIG. 2f is taken along a line A3-A3 shown in FIG. 2c. Concerning each of the cross-sections shown in FIGS. 2d-2f, the geometric section plane is parallel with the xy-plane of the coordinate system 299. The rotor 201a is otherwise similar to the rotor 201 illustrated in FIGS. 2a and 2b but, as shown in FIGS. 2e and 2f, the layers of the non-ferromagnetic material are shaped to form axial channels for conducting cooling fluid e.g. air. In FIG. 2f, one of the axial channels is denoted with a reference 240. For example, as shown in FIG. 2f, the layer 207 of the non-ferromagnetic material has a center portion and side portions so that axial channels are formed between the center portion and the side portions. It is also possible to have e.g. axial grooves on the layers of the non-ferromagnetic material so as to form the axial channels. In this exemplifying case, the layers of the non-ferromagnetic material are shaped to form outlet channels from the axial channels to the airgap surface of the rotor so that the rotor constitutes a blower when the rotor is rotating. In FIGS. 2c and 2e, one of the outlet channels is denoted with a reference 241. In FIG. 2c, a flow of cooling fluid is depicted with a dashed line 250. In this exemplifying case, the outlet channels are located at one end of the rotor 201a. In cases where a stator has a radial cooling channel in the middle of the stator, the outlet channels are advantageously located in the middle of the rotor. It is also possible that the axial channels extend through the rotor in the axial direction and there are no outlet channels of the kind discussed above.

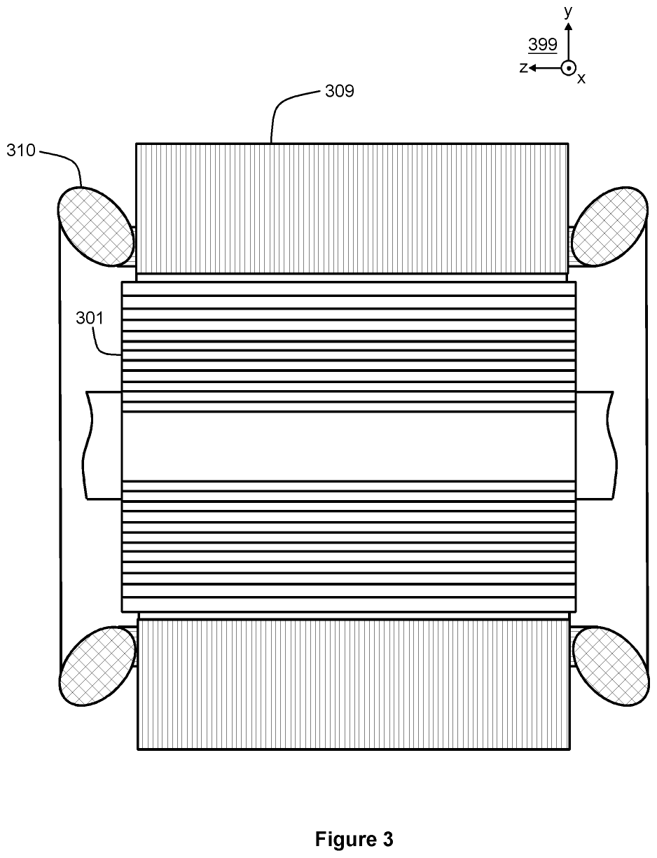

FIG. 3 illustrates a synchronous reluctance machine according to an exemplifying and non-limiting embodiment of the invention. The synchronous reluctance machine comprises a rotor 301 according to an embodiment of the invention and a stator 309. The rotor 301 is rotatably supported with respect to the stator 309. Arrangements for rotatably supporting the rotor 301 with respect to the stator 309 are not shown in FIG. 3. The stator 309 comprises stator windings 310 for generating a rotating magnetic field in response to being supplied with alternating currents. The stator windings 310 can be for example a three-phase winding. The rotor 301 can be for example such as illustrated in FIGS. 1a and 1b, or such as illustrated in FIGS. 2a and 2b, or such as illustrated in FIGS. 2c-2f.

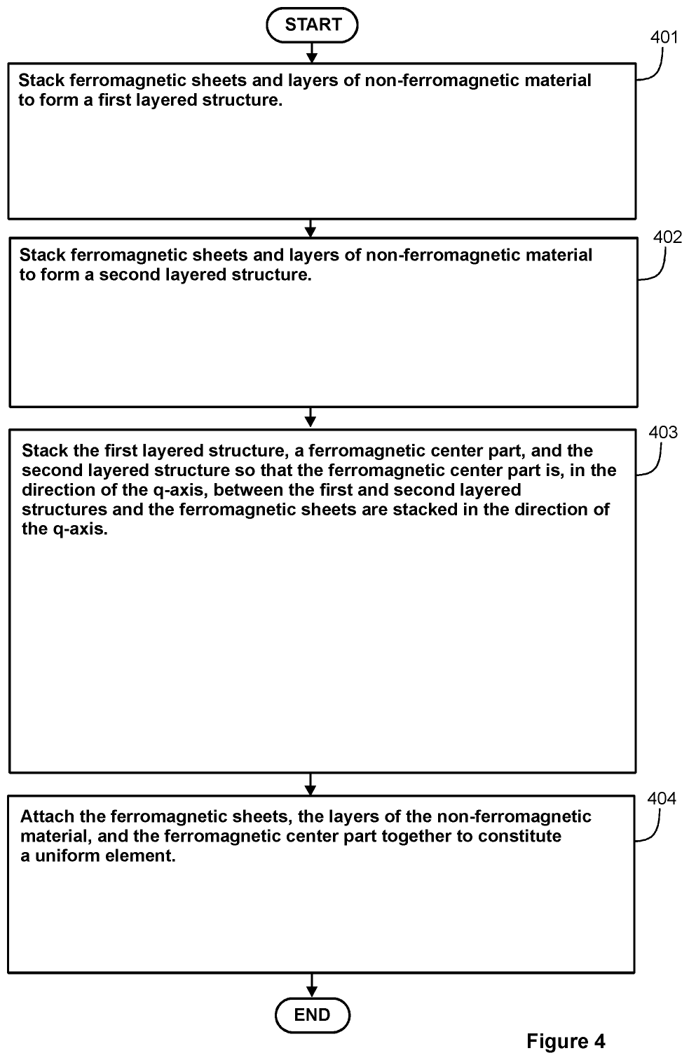

FIG. 4 shows a flowchart of a method according to an exemplifying and non-limiting embodiment of the invention for manufacturing a rotor of a synchronous reluctance machine. The method comprises the following actions:
action 401: stacking first ferromagnetic sheets and first layers of non-ferromagnetic material so as to form a first layered structure where the first layers of the non-ferromagnetic material separate the first ferromagnetic sheets from each other,
action 402: stacking second ferromagnetic sheets and second layers of the non-ferromagnetic material so as to form a second layered structure where the second layers of the non-ferromagnetic material separate the second ferromagnetic sheets from each other,
action 403: stacking the first layered structure, a ferromagnetic center part, and the second layered structure so that the ferromagnetic center part is, in the direction of the quadrature q axis of the rotor, between the first and second layered structures and the first and second ferromagnetic sheets are stacked in the direction of the q-axis, the ferromagnetic center part being a single piece of ferromagnetic material that is wider in the direction of the direct d axis of the rotor than in the direction of the q-axis, and the width of the ferromagnetic center part in the direction of the q-axis being greater than the thickness of the ferromagnetic sheets, and
action 404: attaching the first and second ferromagnetic sheets, the first and second layers of the non-ferromagnetic material, and the ferromagnetic center part together to constitute a uniform element.

It is worth noting that the actions 401-403 can be carried out in an order different from the order mentioned above and presented in FIG. 4.

In a method according to an exemplifying and non-limiting embodiment of the invention, the above-mentioned attaching is implemented by soldering or brazing.

In a method according to an exemplifying and non-limiting embodiment of the invention, the above-mentioned attaching is implemented by diffusion welding.

In a method according to an exemplifying and non-limiting embodiment of the invention, the ferromagnetic sheets are planar and surfaces of the ferromagnetic center part attached to the first and second layered structures are planar and parallel with each other.

In a method according to an exemplifying and non-limiting embodiment of the invention, the ferromagnetic sheets are curved having concave sides towards the ferromagnetic center part, and surfaces of the ferromagnetic center part attached to the first and second layered structures are curved so that the width of the ferromagnetic center part in the direction of the quadrature axis is tapering towards edges of the ferromagnetic center part.

In a method according to an exemplifying and non-limiting embodiment of the invention, the ferromagnetic sheets and the ferromagnetic center part are made of ferromagnetic steel and the non-ferromagnetic material is austenitic steel.

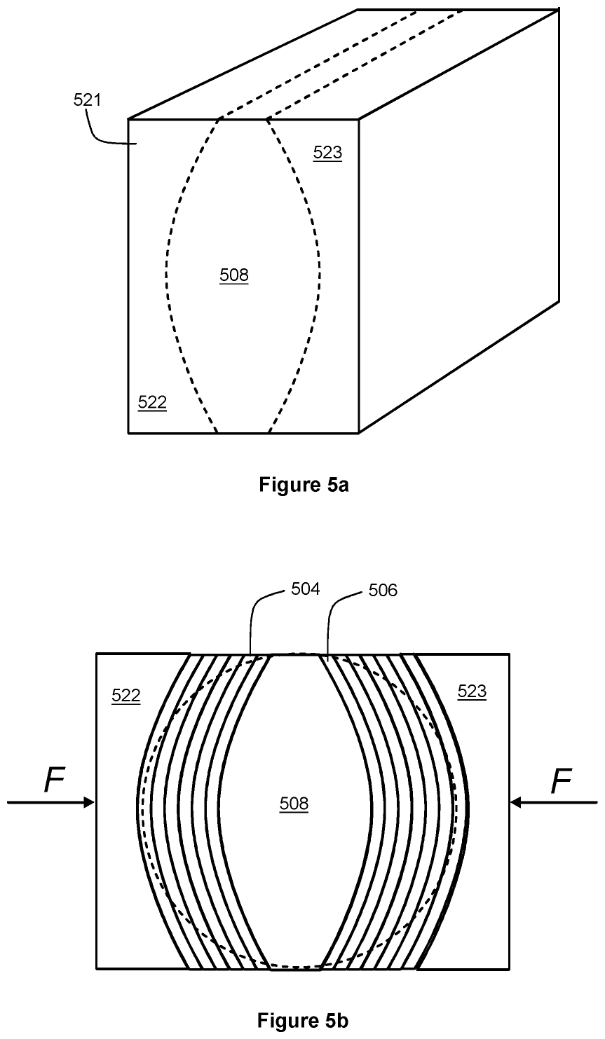

FIGS. 5a and 5b illustrate phases of a method according to an exemplifying and non-limiting embodiment of the invention for manufacturing a rotor of a synchronous reluctance machine. The method comprises cutting the above-mentioned ferromagnetic center part from a block 521 of ferromagnetic material e.g. ferromagnetic steel. In FIGS. 5a and 5b, the ferromagnetic center part is denoted with a reference 508. The cutting can be for example wire cutting. Thereafter, remnant pieces 522 and 523 of the block 521 are used as pressing tools for pressing the ferromagnetic sheets and the layers of the non-ferromagnetic material against the ferromagnetic center part 508 so as to shape the ferromagnetic sheets and the layers of the non-ferromagnetic material to have the desired curved shapes. In FIG. 5b, one of the ferromagnetic sheets is denoted with a reference 504 and one of the layers of the non-ferromagnetic material is denoted with a reference 506. The ferromagnetic sheets, the layers of the non-ferromagnetic material, and the ferromagnetic center part 508 are attached together e.g. by soldering, brazing, or diffusion welding. Thereafter, the resulting rotor preform is lathed according to a dashed line circle shown in FIG. 5b.

In a method according to an exemplifying and non-limiting embodiment of the invention, the ferromagnetic sheets, the ferromagnetic center part, and the layers of the non-ferromagnetic material are made using the hot isostatic pressing “HIP” which reduces porosity of metals and thus increases the mechanical strength. It is also possible that the ferromagnetic sheets and the layers of the non-ferromagnetic material are deposited on the ferromagnetic center part and on each other using the HIP. In this exemplifying case, some of the method phases shown in FIG. 4 are merged and carried out simultaneously.

The specific examples provided in the description given above should not be construed as limiting the applicability and/or the interpretation of the appended claims. Lists and groups of examples provided in the description given above are not exhaustive unless otherwise explicitly stated.

1. A rotor for a synchronous reluctance machine, the rotor comprising:
a first layered structure comprising first ferromagnetic sheets stacked in a direction of a quadrature axis of the rotor, the first ferromagnetic sheets being separated from each other by first layers of non-ferromagnetic material,
a second layered structure comprising second ferromagnetic sheets stacked in the direction of the quadrature axis of the rotor, the second ferromagnetic sheets being separated from each other by second layers of the non-ferromagnetic material, and
ferromagnetic center part located between the first and second layered structures in the direction of the quadrature axis of the rotor and attached to the first and second layered structures, the ferromagnetic center part being a single piece of ferromagnetic material that is wider in a direction of a direct axis of the rotor than in the direction of the quadrature axis of the rotor, and a width of the ferromagnetic center part in the direction of the quadrature axis being greater than a thickness of each of the first and second ferromagnetic sheets.

2. The rotor according to claim 1, wherein the first and second ferromagnetic sheets are planar, and surfaces of the ferromagnetic center part attached to the first and second layered structures are planar and parallel with each other.

3. The rotor according to claim 1, wherein the first and second ferromagnetic sheets are curved having concave sides towards the ferromagnetic center part, and surfaces of the ferromagnetic center part attached to the first and second layered structures are curved so that the width of the ferromagnetic center part in the direction of the quadrature axis is tapering towards edges of the ferromagnetic center part.

4. The rotor according to claim 1, wherein the first and second ferromagnetic sheets and the ferromagnetic center part are made of ferromagnetic steel.

5. The rotor according to claim 1, wherein the non-ferromagnetic material is austenitic steel.

6. The rotor according to claim 1, wherein the rotor comprises solder or brazing joints for attaching the first and second ferromagnetic sheets, the first and second layers of the non-ferromagnetic material, and the ferromagnetic center part together to constitute a uniform element.

7. The rotor according to claim 1, wherein the rotor comprises diffusion welded joints for attaching the first and second ferromagnetic sheets, the first and second layers of the non-ferromagnetic material, and the ferromagnetic center part together to constitute a uniform element.

8. The rotor according to claim 1, wherein the first and second layers of the non-ferromagnetic material are shaped to form axial channels (240) for conducting cooling fluid.

9. The rotor according to claim 8, wherein the first and second layers of the non-ferromagnetic material are shaped to form outlet channels from the axial channels to an airgap surface of the rotor so as to constitute a blower when the rotor is rotating.

10. A synchronous reluctance machine comprising:
a stator comprising stator windings for generating a rotating magnetic field in response to being supplied with alternating currents, and
a rotor rotatably supported with respect to the stator,
the rotor comprising:
a first layered structure comprising first ferromagnetic sheets stacked in a direction of a quadrature axis of the rotor, the first ferromagnetic sheets being separated from each other by first layers of non-ferromagnetic material,
a second layered structure comprising second ferromagnetic sheets stacked in the direction of the quadrature axis of the rotor, the second ferromagnetic sheets being separated from each other by second layers of the non-ferromagnetic material, and
a ferromagnetic center part located between the first and second layered structures in the direction of the quadrature axis of the rotor and attached to the first and second layered structures, the ferromagnetic center part being a single piece of ferromagnetic material that is wider in a direction of a direct axis of the rotor than in the direction of the quadrature axis of the rotor, and a width of the ferromagnetic center part in the direction of the quadrature axis being greater than a thickness of each of the first and second ferromagnetic sheets.

11. A method for manufacturing a rotor of a synchronous reluctance machine, the method comprising:
stacking first ferromagnetic sheets and first layers of non-ferromagnetic material so as to form a first layered structure where the first layers of the non-ferromagnetic material separate the first ferromagnetic sheets from each other, and
stacking second ferromagnetic sheets and second layers of the non-ferromagnetic material so as to form a second layered structure where the second layers of the non-ferromagnetic material separate the second ferromagnetic sheets from each other,
stacking the first layered structure, a ferromagnetic center part, and the second layered structure so that the ferromagnetic center part is, in a direction of a quadrature axis of the rotor, between the first and second layered structures and the first and second ferromagnetic sheets are stacked in the direction of the quadrature axis, the ferromagnetic center part being a single piece of ferromagnetic material that is wider in a direction of a direct axis of the rotor than in the direction of the quadrature axis of the rotor, and a width of the ferromagnetic center part in the direction of the quadrature axis being greater than a thickness of each of the first and second ferromagnetic sheets, and
attaching the first and second ferromagnetic sheets, the first and second layers of the non-ferromagnetic material, and the ferromagnetic center part together to constitute a uniform element.

12. The method according to claim 11, wherein the first and second ferromagnetic sheets are planar, and surfaces of the ferromagnetic center part attached to the first and second layered structures are planar and parallel with each other.

13. The method according to claim 11, wherein the first and second ferromagnetic sheets are curved having concave sides towards the ferromagnetic center part, and surfaces of the ferromagnetic center part attached to the first and second layered structures are curved so that the width of the ferromagnetic center part in the direction of the quadrature axis is tapering towards edges of the ferromagnetic center part.

14. The method according to claim 13, wherein the method comprises cutting the ferromagnetic center part from a block of ferromagnetic material, and using remnant pieces of the block of the ferromagnetic material as pressing tools for pressing the first and second ferromagnetic sheets and the first and second layers of the non-ferromagnetic material against the ferromagnetic center part so as to shape the first and second ferromagnetic sheets and the first and second layers of the non-ferromagnetic material to have curved shapes.

15. The method according to claim 11, wherein the first and second ferromagnetic sheets and the ferromagnetic center part are made of ferromagnetic steel and the non-ferromagnetic material is austenitic steel.

16. The method according to claim 11, wherein the attaching is implemented by soldering or brazing.

17. The method according to claim 11, wherein the attaching is implemented by diffusion welding.

18. The method according to claim 11, wherein the first and second ferromagnetic sheets, the ferromagnetic center part, and the first and second layers of the non-ferromagnetic material are made with a hot isostatic pressing process.

19. The method according to claim 18, wherein the first and second ferromagnetic sheets and the first and second layers of the non-ferromagnetic material are deposited on the ferromagnetic center part and on each other using the hot isostatic pressing process.

20. The rotor according to claim 2, wherein the first and second ferromagnetic sheets and the ferromagnetic center part are made of ferromagnetic steel.
